(19) United States
(12) Patent Application Publication
(10) Pub. No.: US 2014/0155026 A1
(43) Pub. Date: Jun. 5, 2014

(54) METHOD FOR SETTING SPAM STRING IN MOBILE DEVICE AND DEVICE THEREFOR

(71) Applicant: Jae Seok Ahn, Arlington, VA (US)

(72) Inventor: Jae Seok Ahn, Arlington, VA (US)

(21) Appl. No.: 14/002,726

(22) PCT Filed: Mar. 12, 2012
(86) PCT No.: PCT/KR2012/001782

§ 371 Date: Dec. 26, 2013

(30) Foreign Application Priority Data
Mar. 15, 2011 (KR) 10-2011-0022745

(51) Int. Cl. H04W 12/00; H04W 4/12

(52) U.S. Cl. CPC H04W 12/00; H04W 4/12
USPC 455/410

(57) ABSTRACT

The present invention relates to configuring spam strings in a mobile device which receives text messages through a wireless communication network. When a part or all of a received text message is selected on the screen showing the contents of the received text message, a menu for instantly registering the selected portion as a spam string is displayed. Accordingly, a user may avoid an inconvenience caused in memorizing the spam string, opening a spam filtering configuration menu and then manually typing the spam string accurately in the spam filtering configuration menu. Further, since the spam string to be set is directly copied from an actually received spam text message, a recent trend of spam text messages can be taken into consideration setting the spam string.

### FIELD

The present invention relates to method and apparatus for setting spam filtering information used for filtering text messages received at mobile devices such as cellular phone, smart phone, etc.

### RELATED ART

In line with the dissemination of the Internet, massive amount of information and many services are being provided on-line. Various economic activities are implemented on line and many service providers now utilize private information of individuals for the purpose of effective advertisement and successful marketing. As a result, flooding of spam e-mails had been a big issue and most of e-mail service providers have adopted to implement spam e-mail filtering option for their users.

Nowadays, most people carry a cellular phone, which made spam messages via SMS (Short Messaging Service) a bigger problem than spam e-mails. Spam SMS messages may practically create greater disturbance to daily life or business activities than spam e-mails, particularly when spam messages are received too often due to the leakage of private information, because people tend to check incoming SMS messages immediately.

In order to address this issue, recent mobile phones usually features a function of blocking spam calls or spam text messages based on spam phone number or spam string preset by the user. Further, some wireless communication service providers prevent spam calls or spam text messages from reaching their customers' phones based on filtering information that had been set via the web by each user.

However, in order to benefit from this new function or service, users need to manually type the filtering information, i.e., a spam phone number or a spam string, on the menu screen of their phones or web page provided by corresponding wireless communication service provider. Moreover, predicting a spam string may be inefficient because it may not used at all by spammers and further it may block other normal messages that should not be blocked. Spammers use a wide variety of strings and spam strings tend to reflect social/cultural trends. Furthermore, a spam text message once used is very likely to be reused without any changes. In this light, it may be effective to set filtering information using words or symbols as included in actually received spam message rather than to depend on wild guess.

Nevertheless, in order to do so, users still need to face the hassles of opening a text message reading menu, checking incoming messages, navigating to and opening a spam filtering configuration menu, and then manually typing the spam string accurately. Recently, spammers often put meaningless symbols such as “!”, “̂”, or “@” in the spam message to avoid being blocked as a spam, which makes it trickier to memorize the received spam string and then type it accurately as filtering information.

### TECHNICAL PROBLEMS

A method for efficiently setting information used in filtering spam text messages at a mobile device that receives text messages, such as cellular phone, smart phone, etc. is required.

### SOLUTION TO THE TECHNICAL PROBLEMS

The present invention provides a method and an apparatus for efficiently setting information used in filtering spam text messages at a mobile device that receives text messages, such as cellular phone, smart phone, etc.

### ADVANTAGEOUS EFFECT

According to the present invention, a user may set spam filtering information easily and conveniently without a burden to memorize and type manually the symbols or letters included in a spam text message, by merely designating the string in question directly from the received spam text message.

Further, spam text messages can be efficiently blocked taking into account a recent trend of spam text messages that are substantially in use.

### DESCRIPTION OF THE DRAWINGS

FIG. 1 is a flow chart illustrating an overall description of how a spam string is set according to an embodiment of the present invention;

FIG. 2 shows a screen of mobile device that is operable to set the spam string according to an embodiment of the present invention;

FIG. 3 is a block diagram of a mobile device which is configured to set spam strings according to an embodiment of the present invention.

### SUMMARY OF THE INVENTION

An exemplary embodiment of the present invention provides a method for a mobile device receiving text messages through a wireless communication network to process data, the method comprising the steps of: receiving a user input of selecting a part or all of the contents of a received text message while displaying the contents of the text message; displaying a selective menu inquiring whether to register the selected portion of the text message as a spam string in response to the user input; and determining the selected portion of the text message as spam filtering information that applies to text messages to be received at the mobile device when a user input of confirming the registration of the selected portion of the text message as a spam string is received via the selective menu.

It is preferable that the method further includes the steps of: executing a configuration menu of the mobile device or an application which provides a spam text message filtering service for the mobile device; and prepopulating automatically a text box provided in the configuration menu or the application with the spam filtering information wherein the text box receives inputs for spam strings.

It is preferable that the method further includes the steps of: displaying a web page for providing a spam text message filtering service provided by a wireless communication service provider for the mobile device; and prepopulating automatically a text box provided in the web page with the spam filtering information wherein the text box receives inputs for spam strings.

Another exemplary embodiment of the present invention provides a mobile device receiving text messages through a wireless communication network to process data, the mobile device comprising: an input/output means which is operable to receive a user input of selecting a part or all of the contents of a received text message while displaying the contents of the text message; a menu generating means which is operable to generate a selective menu inquiring whether to register the selected portion of the text message as a spam string and display it through the input/output means in response to the user input; and a determining means which is operable to determine the selected portion of the text message as spam filtering information that applies to text messages to be received at the mobile device when a user input of confirming the registration of the selected portion of the text message as a spam string is received via the selective menu.

It is preferable that the determining means is operable to execute a configuration menu of the mobile device or an application which provides a spam text message filtering service for the mobile device, and prepopulate a text box provided in the configuration menu or the application with the spam filtering information wherein the text box receives inputs for spam strings.

It is preferable that the determining means is operable to display a web page for providing a spam text message filtering service by a wireless communication service provider for the mobile device through the input/output means, and prepopulate a text box provided in the web page with the spam filtering information wherein the text box receives inputs for spam strings.

Another exemplary embodiment of the present invention provides a computer readable recording medium having embodied thereon a computer program for a mobile device to process data.

### DETAILED DESCRIPTION

Hereinafter, desirable embodiments of the present invention will be described in great detail referring to the drawings.

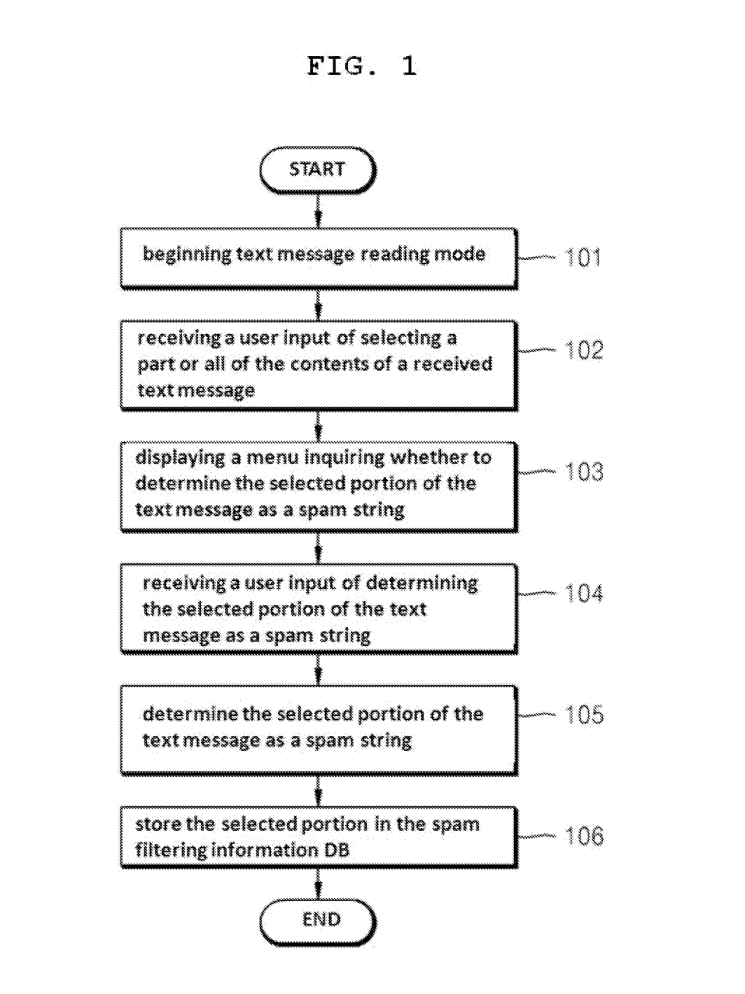

FIG. 1 is a flow chart illustrating an overall description of how a spam string is set according to an embodiment of the present invention.

In step 101, the mobile device according to an embodiment of the present invention begins text message reading mode in which the mobile device displays the contents of a received text message in response to a user input to do so. Generally, a “mobile device” refers to a mobile phone, but it is not limited thereto and it should be broadly interpreted to include any type of devices that receive text messages via wireless communication network and displays them for a user.

In step 102, the mobile device receives user input to select a part or all of the contents of the received text message, on the screen displaying the contents of the received text message. The selected portion of the text message may include a character, a number or a symbol, and the user input may be communicated through a key pad or a touch screen.

In step 103, when the user input of selecting a part or all of the contents of the text message is received, the mobile device automatically displays a selective menu inquiring whether to determine the selected portion of the text message as a spam string.

In step 104, the mobile device receives a user input of determining the selected portion of the text message as a spam string via the selective menu mentioned in step 103.

In step 105, the mobile device determines the selected string of the text message as spam filtering information which applies to text messages to be received at the mobile device after that time.

In step 106, the mobile device stores the spam filtering information determined in step 105 in the spam filtering information database. The implementation of this storing step may vary according to embodiments.

For example, on determining the spam filtering information in step 105, the mobile device may directly stored it in the spam filtering information database. Alternatively, an application providing a spam text message filtering service may be automatically executed, or a native configuration menu of the mobile device for setting spam filtering information may be automatically displayed. It is preferable that a text box of the application or the configuration menu, which enables a user to input spam strings, is automatically prepopulated with spam filtering information determined in step 105. The user may be allowed to further edit the spam filtering information in the text box, or otherwise just confirm the filtering information as it is in order to finally store the spam filtering information in the spam filtering information database.

As another alternative, the mobile device may connect to a server of a wireless communication service provider which provides a wireless communication service for the mobile service, and displays a web page for providing a spam text message filtering service. In this case, the spam filtering information database is likely to embedded in the server. As with other cases, it is still preferable to prepopulate automatically a text box in the web page, which enables a user to input spam strings, with spam filtering information determined in step 105.

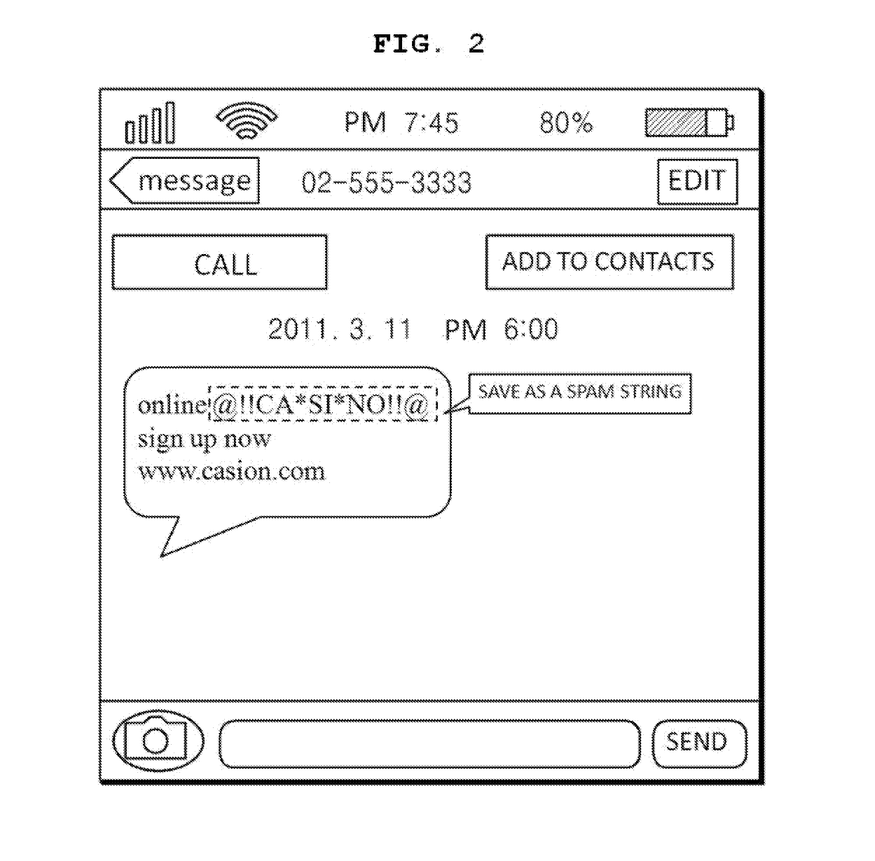

FIG. 2 shows a screen of mobile device that is operable to set the spam string according to an embodiment of the present invention.

As can be seen in FIG. 2, the mobile device in accordance with an embodiment of the present invention displays a menu inquiring a user about whether to determine the selected portion of received text message when the user selects a part or all of the contents of the text message on the screen showing the contents of the received text message.

In FIG. 2, the user selected “@!!CA*SI*NO!!@” part of the text message which is shown as dotted lines and accordingly the mobile device inquires the user about whether to determine the selected “@!!CA*SI*NO!!@” part as spam filtering information by displaying the menu that reads “save as a spam string”. If the user chooses the “save as a spam string” menu via a user interface such as a key pad or a touch screen, “@!!CA*SI*NO!!@” may be determined as a spam filtering information and then stored directly in the spam filtering information database. Alternatively, a native configuration menu of the mobile device for setting spam strings or an application which provides a spam text message filtering service may be automatically executed in order to give the user an opportunity to further edit the selected portion of the text message. Accordingly, it is preferable that a text box provided by the application or the configuration menu, which enables a user to set or edit spam strings, is automatically prepopulated with “@!!CA*SI*NO!!@”.

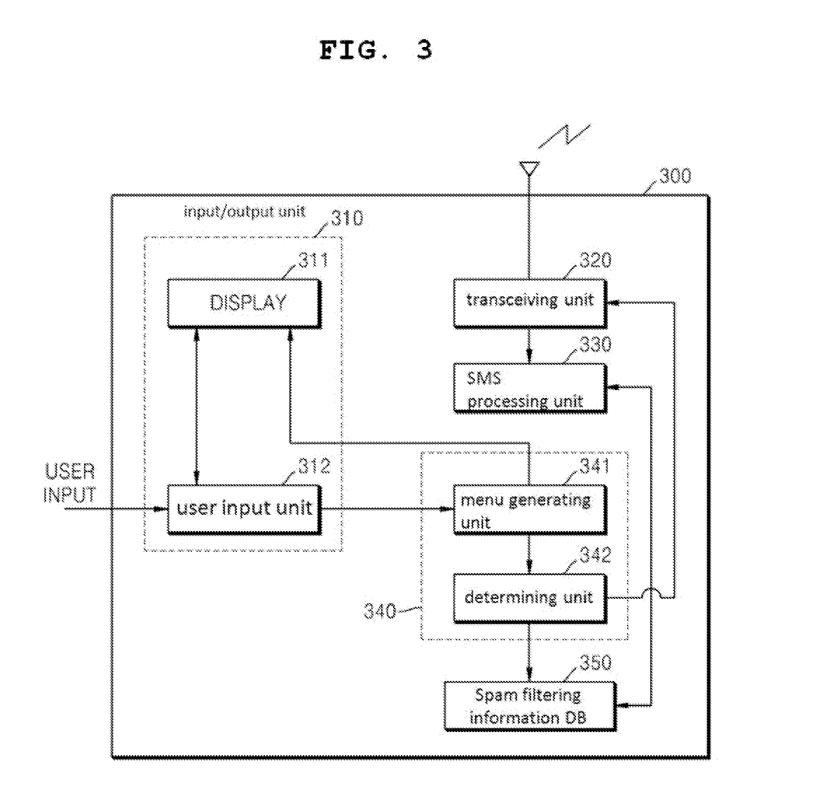

FIG. 3 is a block diagram of a mobile device which is configured to set spam strings according to an embodiment of the present invention.

The mobile device 300 in accordance with an embodiment of the present invention may include a input/output unit 310, a transceiving unit 320, a SMS processing unit 330, a spam processing unit 340 and a spam filtering information database 350.

The input/output unit 310 may provide an interface between the user and the mobile device 300. As shown in the drawing, the input/output unit 310 may include a display unit 311 and a user input unit 312. The display unit 312 may display menu items or text messages for the user. The user input unit 312 may receive diverse input values from the user. The user input unit 312 may be implemented using a touch screen or a key pad, etc. It should be obvious to a skilled person in this field without further explanation that an audio I/O module may be included in the input/output unit 310.

The transceiving unit 320 may communicate with base stations in wireless communication network to receive text messages.

The SMS processing unit 330 may decode text messages received by the transceiver unit 320 to get them displayed by the display unit 311.

The spam processing unit 340 may include a menu generating unit 341 and a determining unit 342 as shown in the drawing to function as a core of the present invention. The menu generating unit 341 may generate a selective menu inquiring whether to determine the selected portion of currently displayed text message as a spam string, and renders the selective menu using the display unit 311 when the user selects a part or all of the text message.

The determining unit 342 may determine the portion selected by the user of the text message as spam filtering information when a user input of confirmation to do so is received using the selective menu, and then executes a native configuration menu of the mobile device for setting spam strings or an application which provides a spam text message filtering service. The determining unit 342 preferably may prepopulate a text box of the application or the configuration menu, which enables a user to input spam strings, with the selected portion of the text message automatically. Alternatively, a web page related to a spam text message filtering service provided by a wireless communication company which provides a wireless communication service for the mobile device may be displayed for further configuration when spam filtering information is determined by the user through the selective menu.

As another alternative, when the user input of confirmation is received using the selective menu, the determining unit 342 may directly register the selected portion as spam filtering information in the spam filtering information database 350 of the mobile device 300.

The spam filtering information database 350 stores spam strings that apply to text messages to be received at the mobile device 300.

The above-described exemplary embodiments can be written as computer programs and can be implemented in general-use digital computers that execute the programs by using a transitory or non-transitory computer readable recording medium.

Examples of the computer readable recording medium include magnetic storage media (e.g., ROM, floppy disks, hard disks, etc.), optical recording media (e.g., CD-ROMs, or DVDs), and/or any other suitable computer readable recording medium.

While the present inventive concept has been particularly shown and described with reference to exemplary embodiments thereof, it will be understood by those of ordinary skill in the art that various changes in form and details may be made therein without departing from the spirit and scope of the exemplary embodiments as defined by the following claims. Accordingly, the disclosed exemplary embodiments should be considered in an illustrative sense rather than a limiting sense. The scope of the present inventive concept is defined not by the detailed description of the exemplary embodiments but by the appended claims, and all differences within the scope will be construed as being included in the present inventive concept.

1. A method for a mobile device receiving text messages through a wireless communication network to process data, the method comprising the steps of:
receiving a user input of selecting a part or all of the contents of a received text message while displaying the contents of the text message;
displaying a selective menu inquiring whether to register the selected portion of the text message as a spam string; and
determining the selected portion of the text message as spam filtering information that applies to text messages to be received at the mobile device when a user input of confirming the registration of the selected Portion of the text message as a spam string is received via the selective menu.

2. The method of claim 1, wherein the determining step includes the steps of:
executing a configuration menu of the mobile device or an application which provides a spam text message filtering service for the mobile device; and
prepopulating automatically a text box provided in the configuration menu or the application with the spam filtering information wherein the text box enables a user to set or edit spam strings for the spam text message filtering service.

3. The method of claim 1, wherein the determining step includes the steps of:
displaying a web page for providing a spam text message filtering service provided by a wireless communication service provider for the mobile device; and
prepopulating automatically a text box provided in the web page with the spam filtering information wherein the text box enables a user to set or edit spam strings for the spam text message filtering service.

4. A mobile device receiving text messages through a wireless communication network to process data, the mobile device comprising:
an input/output means which is operable to receive a user input of selecting a part or all of the contents of a received text message while displaying the contents of the text message;
a menu generating means which is operable to display through the input/output means a selective menu inquiring whether to register the selected portion of the text message as a spam string; and
a determining means which is operable to determine the selected portion of the text message as spam filtering information that applies to text messages to be received at the mobile device when a user input of confirming the registration of the selected portion of the text message as a spam string is received via the selective menu.

5. The mobile device of claim 4, wherein the determining means is operable to execute a configuration menu of the mobile device or an application which provides a spam text message filtering service for the mobile device, and prepopulate automatically a text box provided in the configuration menu or the application with the spam filtering information wherein the text box enables a user to set or edit spam strings for the spam text message filtering service.

6. The mobile device of claim 4, wherein the determining means is operable to display a web page for providing a spam text message filtering service by a wireless communication service provider for the mobile device through the input/output means, and prepopulate automatically a text box provided in the web page with the spam filtering information wherein the text box enables a user to set or edit spam strings for the spam text message filtering service.

7. A non-transitory computer readable recording medium having embodied thereon a computer program for executing the method of claim 1.

8. A method for a mobile device which receives text messages through a wireless communication network to process data, the method comprising,
displaying a selective menu for registering the contents of a received text message as a spam string while showing the contents of the received text message;
displaying a spam string configuration menu of the mobile device and prepopulating automatically a text box provided in the spam string configuration menu with a part or all of the contents of the text message when the selective menu is selected wherein the text box enables a user to set or edit spam strings; and
registering the contents of the text box in a spam filtering information database when a user input of determining the contents of the text box as a spam string is received.

9. A non-transitory computer readable recording medium having embodied thereon a computer program for executing the method of claim 8.

10. A mobile device which receives text messages through a wireless communication network to process data, the method comprising,
a menu generating means which is operable to display on a screen a selective menu for registering the contents of a received text message as a spam string while showing the contents of the received text message;
a determining means which is operable to display a spam string configuration menu of the mobile device, prepopulate automatically a text box provided in the spam string configuration menu with a part or all of the contents of the text message when the selective menu is selected wherein the text box enables a user to set or edit spam strings, and register the contents of the text box in a spam filtering information database when a user input of determining the contents of the text box as a spam string is received.
